(19) United States
(12) Patent Application Publication
(10) Pub. No.: US 2024/0024874 A1
(43) Pub. Date: Jan. 25, 2024

(54) MICROFLUIDIC MAGNETIC MICROBEAD INTERACTION

(71) Applicant: Hewlett-Packard Development Company, L.P., Spring, TX (US)

(72) Inventors: Viktor Shkolnikov, Palo Alto, CA (US); Alexander N. Govyadinov, Corvallis, OR (US)

(73) Assignee: Hewlett-Packard Development Company, L.P., Spring, TX (US)

(21) Appl. No.: 18/021,775

(22) PCT Filed: Aug. 17, 2020
(86) PCT No.: PCT/US2020/046720

§ 371 Date: Feb. 16, 2023

(51) Int. Cl. B01L 3/00

(52) U.S. Cl. CPC B01L 3/502761; B01L 2200/0668; B01L 2400/043; B01L 2300/1827

(57) ABSTRACT

A microfluidic magnetic microbead interaction method may include mixing ferromagnetic microbeads in a fluid while the fluid is at a first temperature above a Curie temperature of the ferromagnetic microbeads, applying a magnetic field to the ferromagnetic microbeads while the fluid is at a second temperature at or below the Curie temperature of the ferromagnetic microbeads and withdrawing remaining supernatant portions of the fluid while the magnetic field is applied to the ferromagnetic microbeads.

### BACKGROUND

Many processes involve the mixing of solutions and the extraction of targeted particles or analyte. Such processes are sometimes used in biochemical analytics. For example, samples are often mixed to facilitate the extraction of nucleic acid for analyses.

### BRIEF DESCRIPTION OF THE DRAWINGS

FIG. 1 is a block diagram schematically illustrating portions of an example microfluidic magnetic microbead interaction device.

FIG. 2 is a block diagram schematically illustrating portions of an example microfluidic magnetic microbead interaction device.

FIG. 3 is a flow diagram of an example microfluidic magnetic microbead interaction method.

FIGS. 4A 4B, 4C, 4D, 4E, 4F, 4G, 4H, and 4I are sectional views schematically illustrating portions of an example microfluidic magnetic microbead interaction method using an example microfluidic magnetic microbead interaction device.

FIGS. 5A and 5B are sectional views illustrating example further microbead interactions following the method of FIGS. 4A-4I.

FIGS. 6A, 6B, 6C, 6D AND 6E are sectional views illustrating example further microbead interactions following the method of FIGS. 4A-4I.

FIGS. 7A, 7B and 7C are sectional views illustrating example further microbead interactions following the example method of FIGS. 4A-4E.

FIG. 8 is a sectional view illustrating an example microfluidic magnetic microbead interaction device.

FIGS. 9A, 9B, 9C, and 9D are sectional views illustrating example further microbead interactions following the example method of FIGS. 4A-4I.

FIGS. 10A, 10B, 10C, 10D, 10D, 10E, 10F, 10G, and 10H are sectional views illustrating portions of an example microfluidic magnetic microbead interaction method.

FIG. 11 is a top view schematically illustrating portions of an example microfluidic magnetic microbead interaction device.

FIG. 12 is a top view schematically illustrating portions of an example microfluidic magnetic microbead interaction device.

FIG. 13 is a top view schematically illustrating portions of an example microfluidic magnetic microbead interaction device.

FIG. 14 is a top view schematically illustrating portions of an example microfluidic igniting microbead interaction device.

FIG. 15 is a perspective view schematically illustrating example ferromagnetic microbeads having different sample coatings.

FIG. 16 is a top view schematically illustrating portions of an example microfluidic magnetic microbead interaction device.

FIG. 17 is a top view schematically illustrating portions of an example microfluidic magnetic microbead interaction device.

Throughout the drawings, identical reference numbers designate similar, but not necessarily identical, elements. The FIGS. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example devices and methods that facilitate the preparation of micro-sized samples and the extraction and/or analyses of targeted particles from the micro-sized samples using magnetic microbeads. The example devices and methods utilize the Curie temperature of the magnetic microbeads, contained in a microfluidic interior, to control the magnetic state of the microbeads to facilitate mixing and targeted particle extraction. To facilitate mixing, the microbeads are heated to a temperature above their Curie temperature to reduce the ferromagnetism of the microbeads. As a result, the microbeads may separate from a magnet and one another for suspension and mixing in a sample solution. During such mixing, microbead attracted particles, such as cells or cellular components, may more readily adhere or attach to surfaces of the microbeads.

Following such attachment, the example devices and methods cool, or allow the microbeads to cool, to a temperature below their Curie temperature. As a result, the microbeads return to a state of ferromagnetism such that the microbeads magnetically aggregate at the magnet. Non-bead attracted particles that have not attached to the magnetic microbeads remain suspended in the solution, separated from the bead attracted particles and ready for extraction. Following extraction of the non-bead attracted particles, the microbead attracted particles may be detached from the microbeads for extraction. Once separated, either or both of the non-bead attracted and the microbead attracted particles may be collected, analyzed, further processed, or repeatedly processed and further analyzed. In some implementations, the process may be repeated to separate different particles from a sample solution in a step-wise manner.

The “particles” being separated may comprise chemical and biological particles. Such targeted “particles” may comprise chemical molecules and biological molecules, such as biological cells or their constituents. Such targeted “particles” may comprise macromolecules such as DNA or proteins

In some implementations, the heating of the microbeads to a temperature above their Curie temperature and the mixing of the microbeads are carried out by distinct components: a separate heater and a separate fluid agitator or mixer. In some implementations, the mixing of the microbeads and the heating of the microbeads to a temperature above the Curie temperature of the microbeads are carried out by a single component or a single type of component. For example, a thermal resistor may be used to heat portions of the sample and the microbeads surrounded by the portions of the sample to a temperature above the Curie temperature of the microbeads, reducing the ferromagnetism of the microbeads to facilitate separation of the microbeads and suspension of the microbeads in the sample through mixing. The same thermal resistor may be used to heat portions of the sample to a temperature above the nucleation temperature of the sample solution, to boil the portions of the solution, creating bubbles that propel and mix the microbeads in the sample solution.

The example devices and methods facilitate automated sample preparation. The mixing and separation may be automatically carried out with a controller that controls the heating of the solution/microbeads, the mixing of the solution/microbeads and the extraction of fluids. For example, a controller may be used to control the timing, duration and amount of heat being applied to the solution/microbeads. A controller may be used to control the timing, duration and force of mixing applied to the solution/microbeads. A controller may be used to control the timing and duration at which a pump supplies or extracts fluid to or from the microfluidic interior. In some implementations, sensors may provide the controller with information regarding the temperature, composition, or state of the solution/microbeads to facilitate closed loop control of such parameters by the controller.

In some implementations, the example devices provide each of sample preparation, particle extraction and particle detection or analyses in one integrated device. For example, in some implementations, the example devices may integrate or incorporate a sensor of that detects properties or the extent of presence of a particular particle. In some implementation, the sensing of the particular particle of interest, the target particle, may occur in the same microfluidic interior which previously contained or currently contains the magnetic microbeads.

In some implementations, the example devices additionally comprise components to facilitate the growth or amplification of particles in the form of biological cells. For example, in some implementations, the example devices may comprise ports for receiving growth media, culture or other fluids to facilitate such growth. In some implementations, the example devices may comprise pumps for selectively controlling the floor supply of such growth media, culture or other fluids. In some implementations, the example devices may include heaters to provide various heating cycles to facilitate amplification of existing cells through polymerase chain reaction (PCR). As a result, such devices provide sample to answer in a single device.

The example devices provide an architecture that is adaptable to various fabrication processes and various uses. For example, the example devices are amenable to integrated circuit and semiconductor fabrication. The example devices are amenable to the use of thermal inkjet fabrication processes. The example devices may be sized to work with both small and large volumes of a sample without significant changes to hardware. The example devices may be used to concentrate target particles prior to reaction for more sensitive detection. Moreover, the example devices may be amenable to multiplexing, wherein multiple mixing and extraction processes (and possibly multiple analytical processes) may be carried out in parallel on a single integrated device.

As will be appreciated, portions of the disclosed microfluidic devices may be formed by performing various microfabrication and/or micromachining processes on a substrate to form and/or connect structures and/or components. Microfluidic interiors, provided by microfluidic channels and/or chambers, may be formed by performing etching, microfabrication processes (e.g., photolithography), or micromachining processes in a substrate. Accordingly, microfluidic channels and/or chambers may be defined by surfaces fabricated in the substrate of a microfluidic device. In some implementations, microfluidic channels and/or chambers may be formed by an overall package, wherein multiple connected package components combine to form or define the microfluidic channel and/or chamber.

In some examples described herein, a dimension or multiple dimensions of a microfluidic channel, passage and/or capillary chamber may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). For example, some microfluidic channels or passages may facilitate capillary pumping due to capillary force. In addition, examples may couple two or more microfluidic channels or passages to a microfluidic output channel via a fluid junction. A “micro-sized” sample refers to a volume of fluid that is very small such as picoliter scale, nanoliter scale, microliter scale, milliliter scale and the like. The magnetic microbeads received within a microfluidic interior have smaller dimensions such that the individual microbeads may be concurrently received within the microfluidic carrier, may aggregate within the microfluidic interior and may be suspended and mixed within a solution being mixed within the microfluidic interior.

Disclosed are example microfluidic magnetic microbead interaction methods. The example methods may include mixing ferromagnetic microbeads in a fluid while the fluid is at a first temperature above a Curie temperature of the ferromagnetic microbeads, applying a magnetic field to the ferromagnetic microbeads while the fluid is at a second temperature at or below the Curie temperature of the ferromagnetic microbeads and withdrawing remaining supernatant portions of the fluid while the magnetic field is applied to the ferromagnetic microbeads

Disclosed are example microfluidic magnetic microbead interaction devices. The example devices may comprise a body having a microfluidic interior and a port connected to the microfluidic interior, wherein ferromagnetic microbeads are contained within the microfluidic interior and wherein the ferromagnetic microbeads have a Curie temperature. The example device may further comprise a magnet to exert a magnetic force on the ferromagnetic microbeads to attract the ferromagnetic microbeads to a region of the microfluidic interior, a heater to heat fluid in the region to a temperature above the Curie temperature of the ferromagnetic microbeads and a mixer to mix fluid and the ferromagnetic microbeads while the fluid is at the temperature.

Disclosed are example microfluidic magnetic microbead interaction devices that comprise a body having a microfluidic interior and a port connected to the microfluidic interior, the microfluidic interior to receive ferromagnetic microbeads having a Curie temperature. The example devices may further comprise a magnet to exert a magnetic force to the microfluidic interior, a heater to heat fluid introduced into the microfluidic interior, a mixer to mix the fluid in the microfluidic interior and a controller to output control signals to the heater causing the heater to heat the fluid to the temperature above the Curie temperature of the ferromagnetic microbeads and to output control signals to the mixer to mix the fluid and the ferromagnetic microbeads while the fluid is at the temperature above the Curie temperature of the ferromagnetic microbeads.

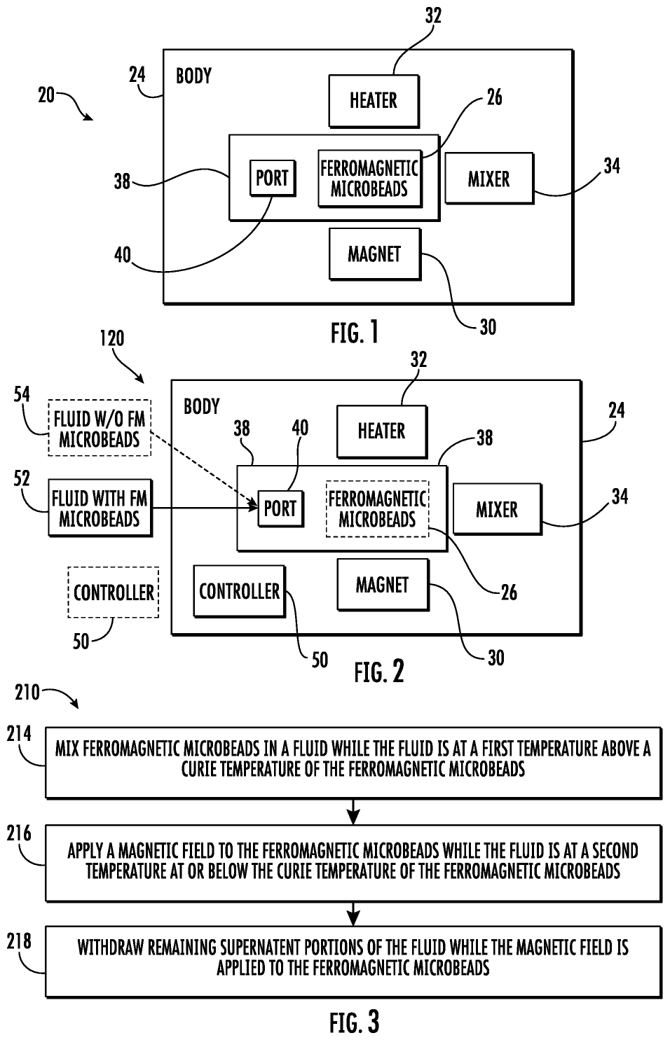

FIG. 1 is a block diagram illustrating portions of an example microfluidic magnetic microbead interaction device 20. Device 20 facilitates the preparation of micro-sized samples and the extraction and/or analyses of targeted particles from the micro-sized samples using magnetic microbeads. Device 20 utilizes the Curie temperature of the magnetic microbeads, contained in a microfluidic interior, to control the magnetic state of the microbeads to facilitate mixing and targeted particle extraction. Device 20 comprises body 24, ferromagnetic microbeads 26, magnet 30, heater 32 and mixer 34.

Body 24 comprises a structure formed from a single layer multiple layers so as to define our form a microfluidic interior 38 having a port 40 which is connected to the microfluidic interior 38. Port 40 facilitates the supply of a sample solution, for mixing and particle extraction, to the microfluidic interior 38. In some implementations, port 40 further facilitates the supply of various other fluids such as additional samples, washing fluids, growth cultures, master mixes, primers, elution fluids and the like. In some implementations, body 24 comprises silicon, glass, ceramics, polymers are the like. In some implementations, body 24 may comprise a microfluidic die, circuit board or chip.

Ferromagnetic microbeads 26 comprise ferromagnetic particles located within interior 38 and having a Curie temperature. A Curie temperature refers to the temperature above which material or materials of the particle or microbeads 26 lose permanent magnetic properties (ferromagnetism), which may be replaced by induced magnetism. Such ferromagnetic microbeads 26 exist within interior 38 prior to the introduction of a sample containing the particles to be extracted or separated from other particles in the sample. In some implementations, such ferromagnetic microbeads 26 may be located within a fluid within interior 38 prior to the introduction of the sample. In some implementations, such ferromagnetic microbeads 26 may be located within a dry interior 38. For example, in some implementations, such ferromagnetic microbeads 26 may be lyophilized form prior to the introduction of the sample solution into the microfluidic interior 38.

In some implementations, ferromagnetic microbeads 26 may be supplied through port 40 into microfluidic interior 38 prior to the introduction of the sample solution containing the particles that are to be mixed and from which the particles are to be extracted. In those implementations where the ferromagnetic microbeads 26 are pre-supplied within interior 38, prior to the introduction of the sample solution, device 20 may be stored as a complete package ready for use in testing a sample solution without pre-mixing of microbeads into the sample solution. In some implementations, the ferromagnetic microbeads 26 may be supplied through port 40, with the solution that is to be mixed and that contains a particles which are to be extracted from solution.

In some implementations, the ferromagnetic microbeads have an average diameter of 1 um to 2 um or more and an average diameter no greater than 50 um. In some implementations, the ferromagnetic microbeads have a number of 1000 or more. In some implementations, the ferromagnetic microbeads are formed from a single material selected from a group of materials consisting of Cobalt, Iron, Nickel, Gadolinium, Dysprosium; Chromium dioxide, CrO₍₂ₓ₎Fₓ, Fe—Nb Cr—B alloys, Fe—Cr—Ni—Mn alloys, Fe₂O₃, CuO, ZnO, MgO. In some implementations, the ferromagnetic microbeads are formed from multiple materials, either mixed with one another or layered over one another, the multiple material selected from a group of materials consisting of Chromium dioxide, CrO₍₂ₓ₎Fₓ, Fe—Nb_Cr—B alloys, Fe—Cr—Ni—Mn alloys, Fe₂O₃, CuO, ZnO, MgO.

In some implementations, ferromagnetic microbeads 26 have a Curie temperature of 90 C to 100 C, nominally 95 C; of 60 C to 70 C, nominally 65 C; or 70 C to 80 C, nominally 75 C. The lower Curie temperature facilitates the reduction magnetic force or ferromagnetism to facilitate separation and mixing at lower temperatures, temperatures that are sufficiently low such that particles within the fluid and being separated may be less susceptible to damage otherwise occurring at higher temperatures. In some implementation, ferromagnetic microbeads 26 may have other Curie temperatures, greater than the above noted Curie temperatures.

In some implementations, ferromagnetic microbeads 26 may comprise monodispersed (uniform sizes) polystyrene core particles that are each coated with a layer of magnetite and polystyrene. Such magnetic particles or microbeads may be spherical in shape and paramagnetic or super paramagnetic in nature. Examples of commercially available ferromagnetic microbeads 26 having low Curie temperatures include, but are not limited to, SPHERO Carboxyl Ferromagnetic particles, SPHERO Amino Ferromagnetic Particles and SPHERO Amino Fluorescent Carboxyl Ferromagnetic Particles. Such particles have a nominal size ranging from 2 μm to 120 μm. Some cross-linked Carboxyl Ferromagnetic Particles (CFX-10-10) may have a nominal size range from 1 to 2 μm non-uniform granules. For example, SPHERO Carboxyl Ferromagnetic Particles CFM-20-10 have a nominal size of 2 to 2.9 μm. Amino Ferromagnetic Particles AFM-40-10 have a nominal size of 4.0 to 4.5 μm. Fluorescent Yellow Carboxyl Ferromagnetic particles FCFM-2052-2 have a nominal size of 2.0 to 2.9 micrometers. Carboxyl Ferromagnetic particles CFM-1000-5 have a nominal size of 90.0 to 120.0 μm.

In some implementations, the ferromagnetic microbeads 26 may be coated with particular materials that facilitate adherence of particular particles (bead attracted particles) while repelling or not promoting adherence of other particles (non-bead attracted particles). In some implementations, the ferromagnetic microbeads may have multiple coatings. Examples of such coatings include, but are not limited to, antibodies (such as for immunotherapy infectious disease tests), DNA probes (such as for SNPs analyses, nucleic acid extraction and gene diagnostic tests, absorbance (such as for bacteria detection and cell trapping), fluorescent labels (such as for DNA analyses and fluorescence barcoding) and proteins (such as for proteome analyses).

Magnet 30 comprises a body or mass of material supported by body 24 and having composition to produce a magnetic field that exerts a magnetic force on the ferromagnetic microbeads 26 to attract the ferromagnetic microbeads to a region of the microfluidic interior 38. In one implementation, magnet 30 comprises a permanent magnet. In one implementation, magnet 30 comprises an electromagnet. Magnet 30 may comprise a single magnet or multiple individual sub magnets.

Heater 32 comprises a structure or mechanism supported by body 24 that is to heat fluid within the region of microfluidic interior 38 to a temperature above the Curie temperature of the ferromagnetic microbeads 26. Heating the fluid within the region of the microfluidic interior 38 to the temperature above the Curie temperature of the ferromagnetic microbeads 26 results in heating of the ferromagnetic microbeads 26 to a temperature above their Curie temperature. As a result, the magnetic attractive forces or ferromagnetism of the ferromagnetic microbeads 26 is reduced to a point such that the ferromagnetic microbeads 26 may be more easily separated from one another and withdrawn from magnet 30 for mixing by mixer 34. In some implementations, heater 32 heats the fluid within the region and the ferromagnetic microbeads 26 to a temperature of at least of 90 C to 100 C, nominally 95 C; of 60 C to 70 C, nominally 65 C; or 70 C to 80 C, nominally 75 C.

Mixer 34 comprises a device that agitates, servers and/or mixes fluid within the region of the microfluidic interior 38. In some implementations, mixer 34 comprises a fluid actuator. In one implementation, the fluid actuator may comprise a thermal resistor which, upon receiving electrical current, heats to a temperature above the nucleation temperature of the fluid so as to vaporize a portion of the adjacent fluid to create a bubble which displaces and mixes the fluid. In other implementations, the fluid actuator may comprise other forms of fluid actuators. In other implementations, the individual fluid actuators may be in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

Microfluidic magnetic microbead interactions device 20 facilitates the separation of particles out of a fluid sample solution. In one example series of steps, microfluidic interior 38 first receives a fluid sample solution through port 40. Thereafter, heater 32 heats fluid in a region of interior 38, containing ferromagnetic microbeads 26, to a temperature above Curie temperature of the ferromagnetic microbeads. This results in the ferromagnetic microbeads have reduced ferromagnetism, transitioning to a paramagnetic state such that the microbeads 26 experienced a lower magnetic force. The reduced ferromagnetism facilitates the suspension and mixing of such ferromagnetic microbeads 26 by mixer 34. During such mixing, the ferromagnetic microbeads 26 are spaced and suspended in the sample solution, mixing throughout the sample solution, whereby targeted particles adhere or adsorb to the outer surface of the ferromagnetic microbeads. Thereafter, the sample solution is cooled or permitted to cool to a temperatures below the Curie temperature such that the ferromagnetic microbeads returned to her ferromagnetic state so as to magnetically attached to one another in aggregate once again attracted towards magnet 30, leaving the non-target particles still suspended in the sample solution. Non-targeted particles may then be separated and withdrawn, leaving the targeted particles adhered to the microbeads 26.

In some implementations, heater 32 may be operable in multiple states to serve multiple functions. For example, in some implementations, heater 32 may operate in a first state serving as an inertial pump to move fluid in a particular direction and a second state, serving to heat fluid in the region of the microfluidic interior 38 containing ferromagnetic microbeads 26 to a temperature above the Curie temperature of the ferromagnetic microbeads 26. For example, heater 32 may be a thermal resistor which may be heated to a first temperature, below the nucleation or bubbles generating temperature of the fluid, to heat the fluid to a temperatures above the Curie temperature and also may be heated to a second temperature, greater than the nucleation or bubble generating temperature of the fluid to create a bubble that displaces fluid such as when arranged as a part of an inertial pump.

In some implementations, heater 32 may also serve to assist mixer 34 or to replace mixer 34 in the mixing of the ferromagnetic microbeads 26 while the ferromagnetic microbeads 26 are at a temperature above their Curie temperature. For example, heater 32, in the form of a thermal resistor, may be used to heat portions of the sample solution and the microbeads surrounded by the portions of the sample solution to a temperature above the Curie temperature of the microbeads, reducing the ferromagnetism of the microbeads to facilitate separation of the microbeads and suspension of the microbeads in the sample solution through mixing. The same thermal resistor may be used to heat portions of the sample solution to a temperature above the nucleation temperature of the sample solution, to boil the portions of the solution, creating bubbles that propel and mix the ferromagnetic microbeads 26 in the sample solution.

FIG. 2 is a block diagram schematically illustrating portions of an example microfluidic magnetic microbead interaction device 120. FIG. 2 illustrates an example of how a controller may be provided to control the supply of the sample fluid or solution, the operation of a heater and/or the operation of a mixer to facilitate separation of targeted particles from the solution. Microfluidic magnetic microbead interaction device 120 is similar to device 20 described above except that device 120 additionally comprises controller 50 supported by body 24. As indicated by broken lines, in some implementations, controller 50 may not be supported by body 24, but may be a separate distinct component that communicates with the components supported by body 24. As further shown FIG. 2, in the example illustrated, a fluid 52 containing the ferromagnetic microbeads 26 is supplied through port 40. As indicated by broken lines, in other implementations, the ferromagnetic microbeads 26 may be provided in microfluidic interior 38 prior to the introduction of the fluid 54 which does not contain ferromagnetic microbeads, but may possibly contain analyte or particles of interest to be separated using device 120. Those components of device 120 which correspond to components of device 20 are numbered similarly.

Controller 50 comprises a processor in the form of electronic circuitry that is to follow instructions containing a non-transitory computer-readable medium. In some implementation, such instruction may provide as programming, code or software. In some implementations, such instructions may be provided in the form of an integrated circuit composed of logic componentry. Controller 50 may carry out a heating and mixing method to facilitate the separation of targeted particles, if present, from non-targeted particles. In some implementation, the particles being targeted adhere to the ferromagnetic microbeads 26. In some implementations, the particles being targeted do not adhere to the ferromagnetic microbeads 26, but where the nontargeted particles adhere to the ferromagnetic microbeads 26. In some implementations, controller 50 carries out the example microfluidic magnetic microbead interaction method 210, portions of which are outlined in FIG. 3.

Microfluidic magnetic microbead interaction method 210 facilitates the preparation of micro-sized samples and the extraction and/or analyses of targeted particles from the micro-sized samples using ferromagnetic microbeads. The example devices and methods utilize the Curie temperature of the ferromagnetic microbeads, contained in a microfluidic interior, to control the ferromagnetism of the microbeads to facilitate mixing and targeted particle extraction. Although method 210 is described in the context of being carried out with device 120, it should be appreciated that method 210 may be carried out in any of the disclosed microfluidic magnetic microbead interaction devices or with similar microfluidic magnetic microbead interaction devices.

As indicated by block 214, ferromagnetic microbeads 26 are mixed in a fluid while the fluid is at the first temperature above a Curie temperature of the ferromagnetic microbeads. Because the fluid is at the first temperature above the Curie temperature of the ferromagnetic microbeads, the ferromagnetic microbeads will also be at the first temperature. At such a temperature, the ferromagnetic microbeads have lower magnetic attraction properties (lower ferromagnetism), facilitating their suspension and mixing. The mixing of the ferromagnetic microbeads facilitates the adsorption of particles suspended in the fluid to the outer surfaces of the ferromagnetic microbeads 26. As discussed above, in some implementations, the exterior surfaces of the ferromagnetic microbeads 26 may include coatings or layers that facilitate the adsorption of selected particles. As a result, the selected particles accumulate and attach to the exterior of the individual ferromagnetic microbeads 26.

As indicated by block 216, a magnetic field is applied to the ferromagnetic microbeads while the fluid is at a second temperature at or below the Curie temperature of the ferromagnetic microbeads. Because the fluid (and the ferromagnetic microbeads) are at the second temperature at or below the Curie temperature of the ferromagnetic microbeads, the ferromagnetic microbeads are ferromagnetic such that the ferromagnetic microbeads are drawn to the magnet 30 applying the magnetic field. As a result, the ferromagnetic microbeads, along with the adhered particles, clump or aggregate in regions proximate the magnet 30. Any particles that do not adhere to the surfaces of the ferromagnetic microbeads remain suspended in the fluid, the supernatant.

As indicated by block 218, remaining supernatant portions of the fluid, those portions containing the particles that did not adhere to the ferromagnetic microbeads 26, are withdrawn while the magnetic field is applied to the ferromagnetic microbeads. In some implementation, the remaining supernatant parcel are withdrawn using a fluid pump which moves the supernatant fluid away from the aggregated ferromagnetic microbeads. In some implementations, the parties contained in the supernatant are the targeted particles for further processing, collection or analyses, those particles which have been separated from those particles that adhered to the ferromagnetic microbeads. In some implementations, the particles that have adhered to the ferromagnetic microbeads are the target particles for further processing, collection and/or analyses. In some implementations, the particles that have adhered to the ferromagnetic microbeads may then be washed from the ferromagnetic microbeads for further processing, collection and/or analyses.

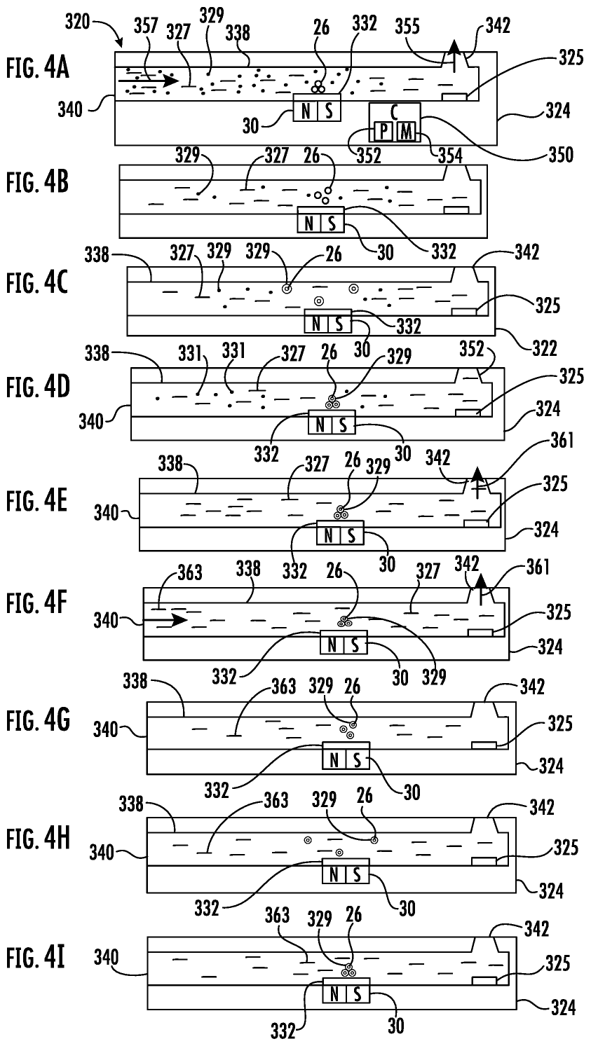

FIGS. 4A-4I illustrate portions of an example microfluidic magnetic microbead interaction device 320 carrying out an example method by which targeted particles are separated from nontargeted particles in a fluid sample solution. As shown by FIG. 4A, device 320 comprises body 324, fluid actuator 325, ferromagnetic microbeads 26, magnet 30, heater/mixer (H/M) 332 and controller 350. Ferromagnetic microbeads 26 and magnet 30 are schematically shown in such FIGS. and are described above with respect to devices 20 and 120. As should be appreciated, ferromagnetic microbeads 26 may have a much larger number and a different proportional size than that schematically shown in such FIGS.

Body 324 is similar to body 24 described above except that body 324 comprises a microfluidic interior in the form of a microfluidic passage 338 having a port 340 through which a fluid solution is supplied into microfluidic passage 338. Body 324 further forms an outlet or nozzle opening 342 through which fluid may be withdrawn or ejected from passage 338. As with body 24, body 324 supports the other components of device 320, such as fluid actuator 325, magnet 30, H/M 332 and controller 50. In some implementations, controller 50 may be supported by structure distinct from body 324. In some implementations, body 24 comprises silicon, glass, ceramics, polymers are the like. In some implementations, body 24 may comprise a microfluidic die, circuit board or chip.

Fluid actuator 325 comprises a device that displaces fluid within microfluidic passage 338. In the example illustrated, fluid actuator 325 is located in close proximity to or opposite to nozzle opening 342 so as to eject fluid through nozzle opening 342, and at the same time, draw fluid into or move fluid along microfluidic passage 338. In one implementation, the fluid actuator 325 may comprise a thermal resistor which, upon receiving electrical current, heats to a temperature above the nucleation temperature of the fluid so as to vaporize a portion of the adjacent fluid to create a bubble which displaces fluid through nozzle opening 342. In other implementations, the fluid actuator 325 may comprise other forms of fluid actuators. In other implementations, fluid actuator 325 may be in the form of a piezo-membrane based actuator, an electrostatic membrane actuator, mechanical/impact driven membrane actuator, a magneto-strictive drive actuator, an electrochemical actuator, and external laser actuators (that form a bubble through boiling with a laser beam), other such microdevices, or any combination thereof.

H/M 332 serves as both heater 32 and mixer 34 (described above with respect to devices 20 and 120). H/M 332 operates in a first mode or state in which H/M 332 heats adjacent fluid to a temperature above the Curie temperature of the ferromagnetic microbeads 26 without substantially mixing fluid or displacing fluid through nozzle orifice 342. H/M 332 operates in a second mode or state in which H/M 332 agitates or mixes the adjacent fluid. In some implementations, H/M 332 comprises a thermal resistor which heats up in response to the passing of electrical current through the thermal resistor. In a first mode of operation, H/M 332 may receive a first amount of current insufficient to create a sufficient amount of heat to vaporize adjacent fluid, but sufficient create enough heat to warm the adjacent fluid to a temperature above the Curie temperature of the ferromagnetic microbeads 26. In a second mode of operation, H/M 332 may receive a second greater amount of current which is sufficient to create a sufficient amount of heat to vaporize (or boil) the adjacent fluid, creating a bubble that displaces and mixes remaining adjacent fluid that has not been vaporized. The actuation between the two modes may be achieved with an electrical switch or other electronic components that control the amount of electrical current being supplied or directed across the thermal resistor of H/M 332. Such actuation may be in response to control signals received from controller 350.

Controller 350 is similar to controller 50 described above in that controller 350 comprises a processing unit 352 that followed instructions contained in a non-transitory computer-readable medium 354. Following such instructions, controller 350 controls the remaining components of device 320 to carry out the microbead interactions shown in FIGS. 4A-4I.

As shown by FIG. 4A, controller 350 outputs control signals causing fluid actuator 325 to displace fluid. As indicated by arrow 355, fluid is ejected through nozzle opening 342. As indicated by arrow 357, this results in fluid 327 being drawn into microfluidic passage 338. The fluid 327 being drawn into microfluidic passage 338 may contain particles 329 of interest, wherein device 320 facilitates the determination of whether such particles 329 exist within the fluid and/or the characteristics of such particles 329. In some implementations, a biological or chemical sample may be diluted with a fluid for circulation through device 320. Examples of such a dilution fluid include, but are not limited to, deionized water, phosphate buffered saline, phosphate buffered sucrose and other buffers. In some implementations, the biological or chemical sample itself may be composed of a fluid that may be circulated through device 320.

As shown by FIG. 4B, controller 350 (shown in FIG. 4A) outputs control signals causing H/M 332 to heat the fluid in the region about ferromagnetic microbeads 26 so as to also heat the ferromagnetic microbeads 26 to a temperature above the Curie temperature of the ferromagnetic microbeads 26. As a result, the ferromagnetic microbeads 26 reduce or lose their ferromagnetism such that they are less likely to adhere to magnet 30 or one another and such that the ferromagnetic micro microbeads 26 are released into the fluid 327.

As shown by FIG. 4C, controller 350 outputs control signals to H/M 332 to cause H/M 332 to heat the fluid in the region of ferromagnetic micro microbeads 26 to a temperature above the nucleation temperature of such fluid so as to boil the fluid or create a bubble that mixes the fluid and mixes the ferromagnetic microbeads 26 while the ferromagnetic microbeads 26 are at a temperature above the Curie temperature of the ferromagnetic microbeads 26. During such mixing, particles 329 adhere or adsorb to the outer surfaces of ferromagnetic microbeads 26. Such mixing may increase the extent to which particles 329 adhere to surfaces of ferromagnetic microbeads 26.

As shown by FIG. 4D, controller 350 outputs control signals to H/M 332 such that any heating by H/M 332 is discontinued or reduced to allow the fluid 327 to cool to a temperature at or below the Curie temperature of the ferromagnetic microbeads 26. This results in the ferromagnetic microbeads 26 regaining their ferromagnetism such that the ferromagnetic microbeads 26 (with the adhered particles 329) once again are magnetically attracted to magnet 30, aggregating at magnet 30. Those particles 331 which are not adhered to the ferromagnetic microbeads 26 remain suspended in the fluid 327.

As shown by FIG. 4E and is indicated by arrow 361, controller 350 outputs control signals causing fluid actuator 325 to displace or eject the remaining fluid or supernatant (less those particles 329 that remain adhered to ferromagnetic microbeads 26) through nozzle opening 342. As shown by FIG. 4F, controller 350 outputs control signals causing a wash fluid 363 to be supplied to microfluidic passage 338. Depending upon the properties of the ferromagnetic microbeads and any coatings thereon as well as the properties of the target particles, the wash fluid has a chemical composition chosen so as to remove unwanted contaminants or other particles (non-target particles) that may also have adhered to the exterior of the ferromagnetic microbeads 26, while facilitating continued adherence of the targeted particle of interest to the ferromagnetic microbeads 26. The continued ejection of fluid through nozzle opening 342 results in the wash fluid 363 being drawn into microfluidic passage 338. In some implementations, the movement of the wash fluid 363 may be further facilitated through the use of additional pumps, such as additional inertial pumps, supported by body 324 and under the control of controller 350. The wash fluid may be a fluid that is pure or a fluid that omits any potential contaminants or particles. Examples of such a wash fluid include, but are not limited to deionized water, phosphate buffered saline, phosphate buffered sucrose, citrate buffered saline, hepes buffered saline, other buffers or a master mix.

FIGS. 4G-4I illustrate an example individual washing cycle. As shown by FIG. 4G, controller 350 outputs control signals causing H/M 332 to once again heat the fluid and the ferromagnetic microbeads 26 to a temperature above the Curie temperature of the ferromagnetic microbeads 26, once again releasing the ferromagnetic microbeads 26 in the wash fluid 363. As shown by FIG. 4H, controller 350 outputs control signals causing H/M 332 to mix the ferromagnetic microbeads 26 in the wash fluid. As shown by FIG. 4I, controller 350 outputs control signals or discontinues the transmission of control signals to H/M 332 such that the temperature of the fluid and ferromagnetic microbeads 26 drops to below the Curie temperature of the ferromagnetic microbeads 26, resulting in the ferromagnetic microbeads 26 regaining their ferromagnetic properties and re-aggregating at magnet 30, wherein the contaminants remain suspended in the wash fluid. The cycle of suspending, mixing, and aggregating the ferromagnetic microbeads 26 shown in FIGS. 4G-4I may be repeated multiple times to facilitate washing of the ferromagnetic microbeads 26. Following such washing cycles, the wash fluid may be ejected through the use of fluid actuator 325 as shown in FIG. 4F. In some implementations, the wash fluid may be ejected as shown in FIG. 4F after each individual washing cycle.

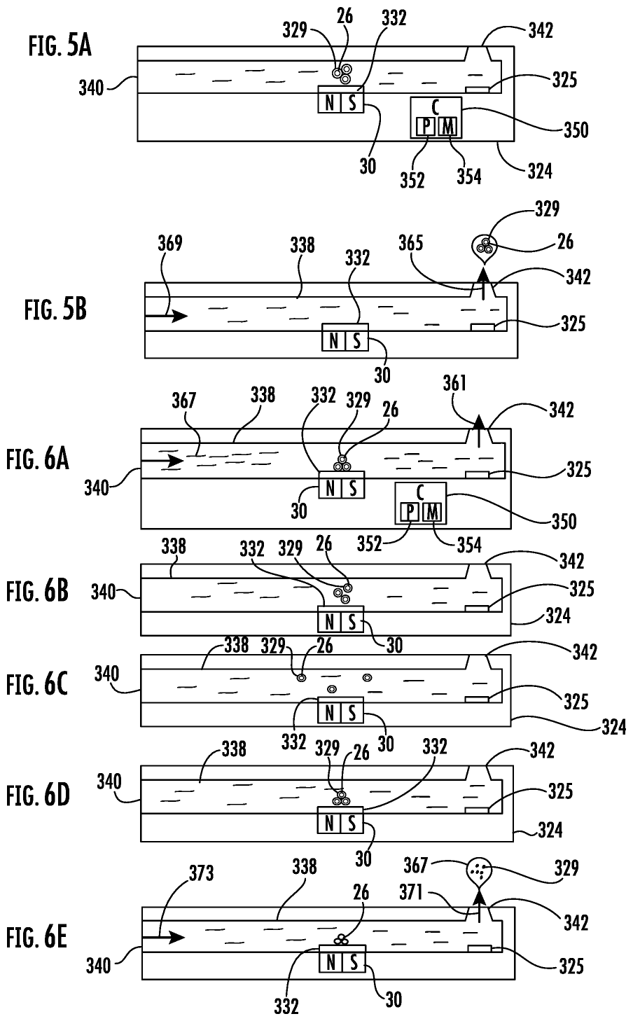

FIGS. 5A and 5B illustrate an example of how the separated target particles 329 may be further collected for analyses. Following the washing cycle or cycles shown in FIGS. 4G-4H, controller 350 may output control signals causing H/M 332 to heat the fluid about ferromagnetic microbeads 26 and ferromagnetic microbeads 26 to a temperature above the Curie temperature of the ferromagnetic microbeads 26, suspending the washed ferromagnetic microbeads 26 and the remaining adhered target particles 329 in the surrounding fluid (the wash fluid or a different suspension fluid). As shown by FIG. 5B and indicated by arrow 365, controller 350 may output control signals to fluid actuator 325 causing fluid actuator 325j′ eject the ferromagnetic microbeads 26 and the adhered particles 329 through nozzle opening 342. The ferromagnetic microbeads and the adhered particles 329 may be collected and/or analyzed. In some implementations, the particles 329 may be separately separated from the ferromagnetic microbeads 26 for collection and/or analyses. As indicated by arrow 369, in some implementations, the ejection of fluid indicated by arrow 365 may further result in a new fluid sample being drawn into microfluidic passage 338 as indicated by arrow 369. Thereafter, the microbead interactions shown in FIGS. 4A-4I and FIGS. 5A-5B may be repeated.

FIGS. 6A-6E illustrate an example of how the separated target particles may be further collected for analyses by further using device 320 to separate the target particles from the ferromagnetic microbeads 26. As shown by FIG. 6A, following the microbead interactions shown and described above with respect to FIGS. 4A-4I, controller 350 outputs control signals to fluid actuator 325, causing fluid actuator 325 to eject the wash fluid 363 through nozzle opening 342 as indicated by arrow 361. Controller 350 further opens up a source of elution fluid to port 340 of microfluidic passage 338. The ejection of fluid through ejection opening 342 results in elution fluid 367 being drawn into microfluidic passage 338.

As shown by FIGS. 6B, 6C and 6D, the microbeads 26 are suspended, mixed and re-aggregated once or multiple times to facilitate removal of the targeted particles from the microbeads 26 by the elution fluid 367. As shown by FIG. 6B, controller 350 outputs control signals to H/M 332 causing H/M 332 to heat the fluid surrounding the microbeads 26 and the microbeads 26 to a temperature above the Curie temperature of the microbeads, resulting the microbeads being released into the elution fluid 367. As shown by FIG. 6C, controller 350 outputs control signals to H/M 332 causing H/M 332 to mix the fluid in the microbeads within the elution fluid 367. As shown by FIG. 6D, controller 350 outputs control signals or discontinues transmitting control signals to H/M 332 such that the fluid 367 about microbeads 26 and microbeads 26 cool to temperature below the Curie temperature of the microbeads 26. This results in the microbeads 26, separated from the target particles 329, re-aggregating or clumping at magnet 30. The microbead interactions shown in FIGS. 6B, 6C and 6D may repeated with multiple cycles.

As shown by FIG. 6E, while the microbeads 26 are at a temperature below their Curie temperature and while the microphone microbeads 26 remain aggregated at magnet 30, controller 350 outputs control signals to fluid actuator 325, causing fluid actor 325 to eject the particles 329, with the elution fluid 367, through nozzle opening 342 as indicated by arrow 371. In some implementations, controller 350 may output control signals causing the supply of elution fluid to be disconnected from port 340 and a new sample supply to be connected to port 340. In such implementations, as indicated by arrow 373, a new sample solution may be drawn into microfluidic passage 338 for processing. In some implementations, a wash fluid may first be circulated through microfluidic passage 338 by fluid actuator 325 prior to the introduction of a new sample solution.

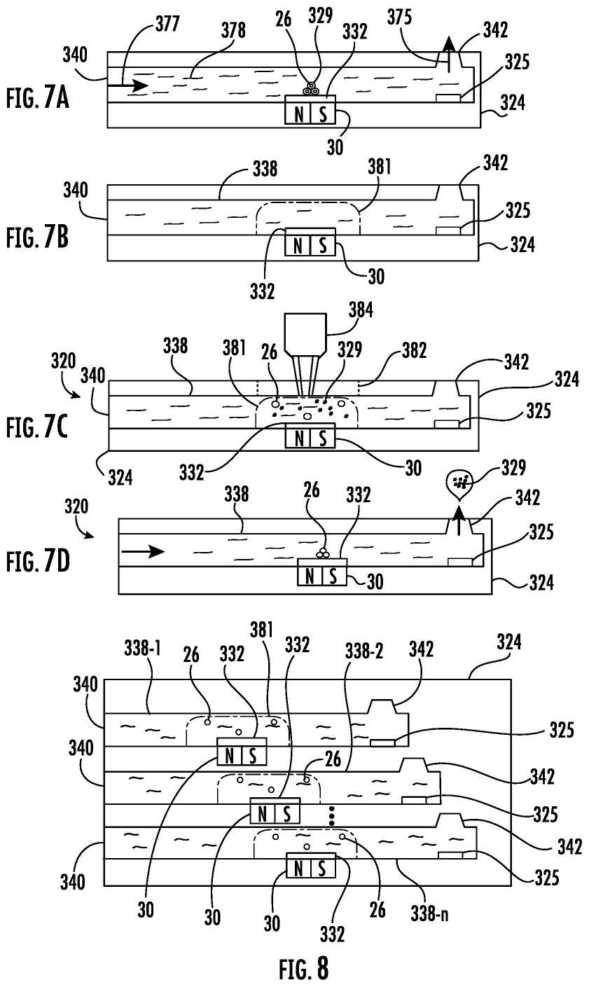

FIG. 7A-7D illustrate an example of how the separated target particles 329 may be further processed and analyzed within device 320. As shown by FIG. 7A, while the microbeads 26 and the adhered target particles 329 are aggregated at magnet 30, controller 350 (shown in FIG. 4A) may output control signals to fluid actuator 325 causing fluid actuator 325 to eject existing fluid through nozzle opening 342 as indicated by arrow 375 and as indicated by arrow 377 to further draw in elution fluid 378 which additionally includes a master mix, a growth culture medium) and primers for the targeted particles 329. In some implementations, controller 350 may output control signals connecting a source of elution fluid 378 to port 340, such as through the actuation of a valve or the like. Following the introduction of the elution fluid 378, controller 350 may output control signals causing device 320 to carry out the suspension, mixing and re-aggregating cycle described above with respect to FIGS. 4G-4I. This cycle may be repeated multiple times to sufficiently separate the particles 329 from the microbeads 26 and to mix separated particles 329 with the elution fluid 378.

As shown by FIG. 7B, following the mixing of the separated particles 329 in the elution fluid 328, the separated particles within microfluidic passage 338 may undergo thermal cycling 381 for amplification such as sometimes employed with polymerase chain reactions (PCR). In the case of PCR, the separated particles 329 may undergo initialization, denaturation, annealing, and extension/elongation to amplify DNA targets to millions of copies. During such thermal cycling, the temperature of the fluid may be above the Curie temperature such that the microbeads 26 also remain suspended.

As shown by FIG. 7C, in some implementations, body 324 comprises a translucent or transparent window 382. Following growth or amplification of the separated target particles 329 within microfluidic passage 338, an optical system 384 may image the fluid within microfluidic passage 338, through window 382, to detect the presence of or otherwise analyze the separated particles 329 within microfluidic passage 338. As shown by FIG. 7D, following such optical detection and/or analyses, controller 350 may output control signals to fluid actuator 325 causing fluid actuator 325 to eject the amplified separated particles 329 through nozzle opening 342. In some implementations, the ejection of the amplified target particles 329 shown in FIG. 7D may be omitted.

As shown by FIG. 8, in some implementations, body 324 may comprise a series of multiple microfluidic passages 338-1, 338-2, . . . 338-n (collectively referred to as microfluidic passages 338), wherein each of the microfluidic passages 338 has an associated magnet 30, an associated H/M 332, an associated fluid ejector 325 and an associated nozzle opening 342. In such an implementation, controller 350 (shown in FIG. 4A) and supported by body 324, independently controls the different components associated with the different microfluidic passages 338 to carry out the above described processes, with different parameters, in each of the different passages 338. In some implementations, each of microfluidic passages 338 may be supplied with different lyophilized primers, different master mixes, different microbeads 26 or different microbeads having different particle attracting coatings. As a result, different types of analyses and/or amplification may be carried out in parallel within the different microfluidic passages 338.

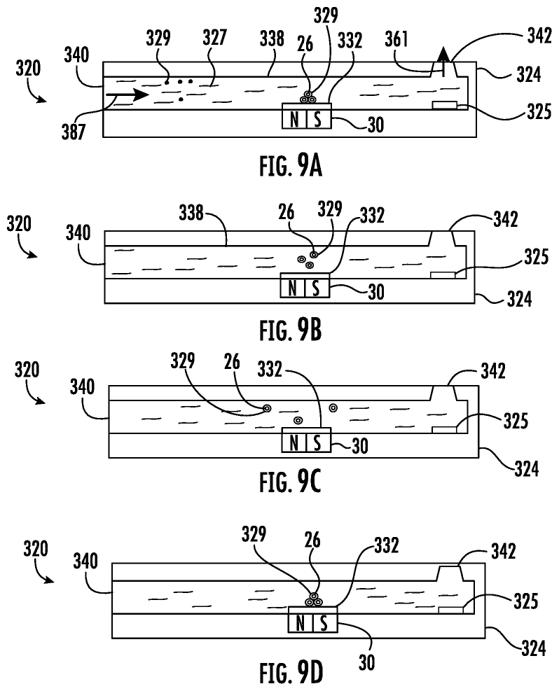

FIGS. 9A-9D illustrate an example of how target particles may be concentrated from large sample volumes using device 320. As shown by FIG. 9A, following the microbeads interactions shown in FIGS. 4A-4E, rather than drawing in a wash fluid as shown in FIG. 4F, controller 350 output control signals connecting a sample solution source to port 340 and outputs control signals to fluid actuator 325 to cause fluid after 325 to draw in more of the sample solution 327 containing particles 329 (as indicated by arrow 387) by ejecting fluid through nozzle opening 342 (as indicated by arrow 361).

As shown by FIGS. 9B, 9C and 9D, controller 350 outputs control signals to suspend, mix and reaggregate microbeads 26, respectively. As shown in FIG. 9B, controller 350 outputs control signals causing H/M 332 to heat the nearby fluid (and the microbeads 26 to which the prior target particles 329 have adhered) to a temperature above the Curie temperature of the microbeads 26, causing the microbeads 26 to lose ferromagnetism and become suspended in the sample solution 327. As shown by FIG. 9C, controller 350 outputs control signals to H/M 332 to cause H/M 332 to bubble mix the suspended microbeads 26. During such mixing, target particles 329 are further concentrated on the surfaces of microbeads 26.

As shown by FIG. 9D, controller 350 outputs control signals to H/M 332 or discontinues the transmission of control signals to H/M 332 such that microbeads 26 are allowed to cool to a temperature below the Curie temperature of the microbeads 26, wherein microbeads 26 regain their ferromagnetism and once again attracted to magnet 30. The series of processes shown in FIGS. 9B, 9C and 9D may be repeated until an entire large sample has been processed. Following processing of the entire sample, the microbeads interactions shown in FIGS. 4G-4I with wash fluid may be carried out. Thereafter, the follow-up microbead interactions shown in FIG. 5A-5B, the follow-up interactions shown in FIGS. 6A-6E or the follow-up microbeads interactions shown in 7A-7D may be carried out.

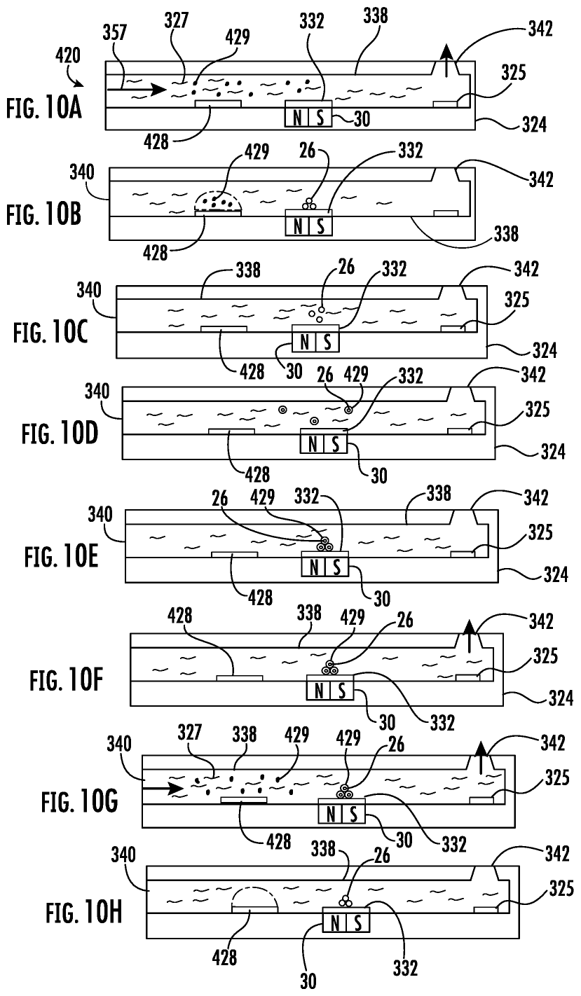

FIGS. 10A-10H illustrate an example microfluidic magnetic microbead interaction device 420 and an example of how device 420 may be utilized to concentrate target particles large sample volumes, with lyses. Microfluidic magnetic microbead interaction device 420 is similar to device 320 described above except that device 420 additionally comprises lyser 428. Those remaining components of device 420 which correspond to components of device 320 are numbered similarly.

Lyser 428 comprises an electronic component supported by body 324 that is operable to that is to facilitate lyses, the breaking down of a membrane of a cell to compromise its integrity and generate a lysate. In the example illustrated, lyser 428 comprises a thermal resistor similar to H/M 332 or fluid actuator 325. In some implementations, lyser 428 heat cells to elevated temperatures to facilitate lyses. In some implementations, lyser 428 sheets adjacent fluid to boil the adjacent fluid, wherein the expanding and collapsing stream bubble results in shear forces that lyse the cells. In the example illustrated, lyser 428 is located upstream of H/M 332, on an opposite side of H/M 332 as fluid actuator 325 and nozzle opening 342.

As shown in FIG. 10A, controller 350 (shown in FIG. 4A) outputs control signals causing fluid actuator 325 to eject fluid through nozzle opening 342, thereby drawing in or loading sample 327 containing cells 429 to be evaluated or analyzed. As shown by FIG. 10B, controller 350 outputs control signals actuating lyser 428 such a lyser 428 lyses cells 429 by heat or shear forces. Upon lysing of the cells 429, controller 350 outputs control signals to carry out the microbead interactions shown in FIGS. 10C-10E which correspond to the microbeads interactions shown and described above in FIGS. 4B-4D, respectively, in which the microbeads 26 are suspended due to the microbeads 26 being heated by H/M 332 to a temperature above their Curie temperatures (FIG. 10C), in which the suspended microbeads are mixed by H/M 332 (FIG. 10D) to facilitate adsorption of the lyse cells or portions of the lyse cells to the outer surfaces of the microbeads 26, and in which microbeads 26 are allowed to cool to a temperature below their Curie temperatures so as to regain ferromagnetism and once again aggregate at magnet 30 (FIG. 10E). Following such aggregation of microbeads 26 with the adhered cell portions or lysed cells, the remaining supernatant is discharged or ejected through nozzle opening 342 by fluid actuator 325.

As shown in FIG. 10G, controller 350 may output control signals causing the sample solution to be connected to port 340 of microfluidic passage 338 and causing fluid actuator 325 to continue to eject fluid through nozzle opening 342 so as to draw in additional sample solution 327 containing non-lysed cells 429. Thereafter, as shown by FIG. 10H, controller 350 may output control signals causing lyser 428 to lyse the newly introduced cells 429, wherein the processes shown and described above with respect to FIGS. may be repeated until all of a sample has been processed.

Following processing of the entire sample, the microbeads 26 with the attached lysed cells or cell portions may be further processed. For example, the microbead interactions shown in FIGS. 4G-4I with wash fluid may be carried out. Thereafter, the follow-up microbead interactions shown in FIG. 5A-5B, the follow-up microbead interactions shown in FIGS. 6A-6E or the follow-up microbead interactions shown in 7A-7D may be carried out with respect to the lysed cells or cell portions (the target particles) which have been separated and filtered out of the sample solution.

FIG. 11 is a schematic diagram illustrating portions of an example microfluidic magnetic microbead interaction device 520. Device 520 may be utilized for carrying out any of the above described methods and processes. Device 520 comprises body 524, sample reservoir 540, wash reservoir 542, elution reservoir 544, pumps 550, 552, 554, mixing loop 558, pump 560 and waste reservoir 564. Body 524 is similar to body 324 described above except that body 524 additionally forms or defines reservoirs 540, 542, 544, mixing loop 558 and waste reservoir 564.

Sample reservoir 540, wash reservoir 542 and elution reservoir 544 comprise chambers formed in body 524 which contain a sample solution, a wash fluid, and an elution fluid, respectively. Such reservoirs 540, 542 and 544 are connected to microfluidic passage 338 and controllably supply their respective fluids, individually, to microfluidic passage 338. In the example illustrated, pumps 550, 552 and 554 are located between reservoirs 540, 542 and 544, respectively, and microfluidic passage 338 to control the flow of the respective solutions or fluids into fluidic passage 338.

In the example illustrated, each of pumps 550, 552 and 554 comprise an inertial pump which moves fluid into microfluidic passage 338, wherein capillary forces otherwise inhibit the flow of such fluids into microfluidic passage 338. In the example illustrated, each of pumps 550, 552 and 554 comprises a fluid actuator in the form of a thermal resistor which displaces fluid through the generation of heat that creates a bubble that displaces fluid. The geometries of microfluidic passage 338, the reservoirs 540, 542 and 544 and the positioning of such thermal resistors result in fluid being directed and moved into microfluidic passage 338 upon actuation of the thermal resistors. In other implementations, pumps 550, 552 and 554 may comprise other forms of fluid actuators (as described above) for displacing fluid and forming the inertial pumps. In other implementations, pumps 550, 552 and 554 may comprise other forms of pumps, other than inertial pumps.

Mixing loop 558 comprises a microfluidic passage having two opposite ends 568, 570 which are connected to microfluidic passage 338. The opposite ends 568, 570 are located on opposite sides of a heating zone 574 within microfluidic passage 338 and generally opposite to H/M 332 and magnet 30. Pump 560 is located within mixing loop 558 approximate to end 570 which is between end 568 and nozzle opening 342.

Pump 560 displaces fluid to move fluid from a portion of microfluidic passage 338 downstream of H/M 332 (on a side of heating zone 574 closest to nozzle opening 342) into mixing loop 558. In some implementations, pump 560 comprises an inertial pump. In some implementations, pump 560 comprises a thermal resistor that vaporizes adjacent fluid to create a bubble that displaces the fluid. In other implementations, pump 560 may comprise other forms of fluid pumps.

Pump 516 circulates microbeads 26 (and attached particles), which have been suspended and mixed by H/M 332, through mixing loop 558 (in the direction indicated by arrow 575) for enhanced mixing and enhanced adsorption of particles to the exterior surfaces of the microbeads 26. Because end 568 of mixing loop 558 is upstream of the heating zone 574 and magnet device 520 may circulate microbeads 26 once or multiple times through mixing loop 558 for enhanced mixing.

Waste reservoir 564 comprises a chamber reservoir formed in body 524 downstream of nozzle opening 342 and fluid actuator 325. Waste reservoir 564 facilitates the collection of wash fluid and elution fluid, wherein the targeted particles (whether attached to microbeads 26 or separated from microbeads 26 as described above) may be controllably ejected through nozzle opening 342 for collection and possible further analyses or processing. In some implementations, waste reservoir 564 may be omitted, wherein the wash fluid and/or elution fluid are also ejected through nozzle opening 342.

Controller 350 is described above. In each of the disclosed implementations, controller 350 may facilitate automated sample preparation. The mixing and separation may be automatically carried out with a controller 350 that controls the heating of the microbeads 26 by H/M 332, the mixing of the solution/microbeads 26 by H/M 332 and pump 560 and the extraction of fluids by fluid actuator 325. Controller 350 may further control the supply of sample fluid are solution, the supply of wash fluid in the supply evolution fluid to microfluidic passage 338 through the control of pumps 550, 552 and 554, respectively. Controller 350 may be used to control the timing and duration at which the individual pump 550, 552 and 554 supplies or extracts fluid to or from the microfluidic path to 338. Controller 350 may be used to control the timing, duration and amount of heat being applied to the heating zone 574 and microbeads 26. Controller 350 may be used to control the timing, duration and force of mixing applied to the microbeads by H/M 332 and by the actuation of pump 560.

In the example illustrated, body 524 additionally comprises various sensors 580-1, 580-2, 580-3 and 580-4 (collectively referred to as sensors 580) supported by body 524 at various locations along microfluidic passage 338 and mixing loop 558 for outputting signals indicating the characteristics (temperature, transparency, color, viscosity) of the fluid within microfluidic passage 338 and/or mixing loop 558, the rate of flow of the fluid, the temperature of the fluid and/or the concentrations or characteristics of targeted and/or non-targeted particles. Such signals may be provided to controller 330 which may use such values in its control of the supply of fluids from sample reservoir 540, wash reservoir 542 or elution reservoir 544, to control the heating and mixing operations performed by H/M 332, to further control the circulation of fluid by pump 560 and to control the ejection of fluid by fluid actuator 325. In some implementations, such sensors 380 may provide information to controller 350 to facilitate closed loop control of such parameters by the controller 350.

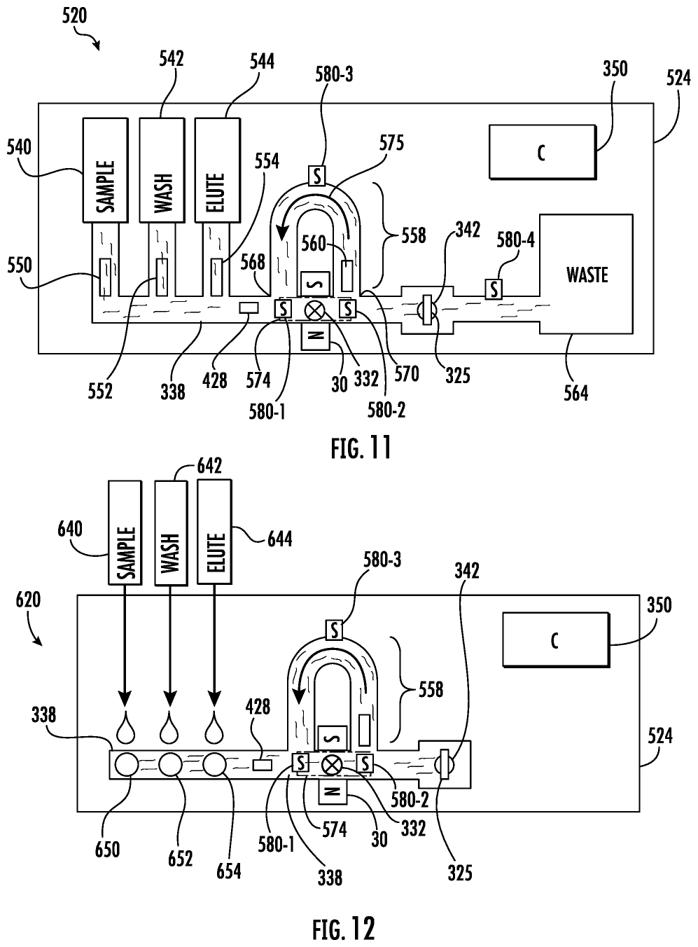

FIG. 12 is a schematic diagram illustrating portions of an example microfluidic magnetic microbead interaction device 620. FIG. 12 illustrates an example microfluidic magnetic microbead interaction device which is supplied with sample fluid, wash fluid and/or elution fluid from remote sources rather than reservoirs provided on the device itself. Device 620 may be utilized for carrying out any of the above described methods and processes. Device 620 is similar device 520 described above except that device 520 omits reservoirs 540, 542 and 544 and instead comprises input ports 650, 652 and 654 formed in body 524 and connected to microfluidic passage 338. Ports 650, 652 and 654 receive sample solution, wash fluid and elution fluid from sample solution source 640, wash fluid source 642 and elution fluid source 644, respectively. The remaining components of device 620 which correspond to components of device 520 are numbered similarly. Unlike device 520, device 620 ejects each of the sample solution, wash fluid and elution fluid through nozzle opening 342 through the controlled actuation of fluid actuator 325 by controller 350.

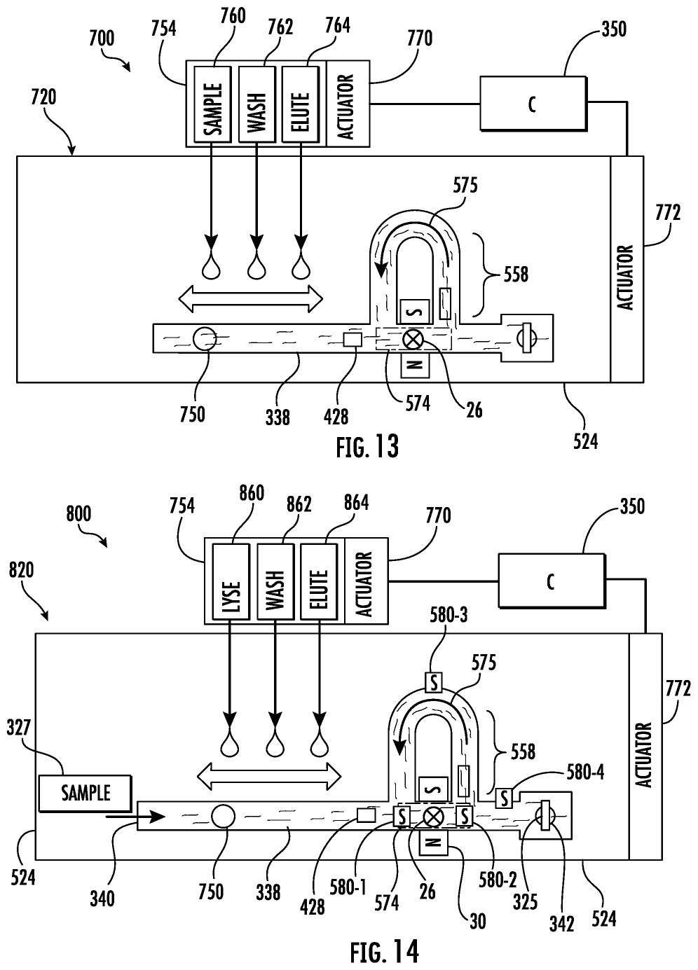

FIG. 13 is a schematic diagram illustrating portions of an example microfluidic magnetic microbead interaction device 720. FIG. 13 illustrates an example microfluidic magnetic microbead interaction device which is supplied with sample fluid, wash fluid and/or elution fluid from remote sources through a single port in the microfluidic body. Device 720 may be utilized for carrying out any of the above described methods and processes. Device 720 is similar to device 620 described above except that device 720 supplies a sample solution, wash fluid and elution fluid through a single port 750 by repositioning the separate fluid sources and/or the single port relative to one another. Device 720 is part of a larger system 700 that additionally comprises carriage 754, sample solution source 760, wash fluid source 762 and elution fluid source 764, actuator 770 and actuator 772. Those components of device 720 which correspond to components of device 620 are numbered similarly and/or are shown and described above with respect to device 620 or device 520. In the example illustrated, controller 350 is separate from body 524. In other implementations, controller 350 may be supported by body 524.

Port 750 comprises an external opening in body 524 for the supply of a sample solution, wash solution and/or elution fluid into microfluidic passage 338.

Carriage 754 supports sample solution source 760, wash fluid source 762 and elution fluid source 764. Actuator 770 controllably repositions the outlet of such sources relative to port 750 for depositing such fluids into port 750. Actuator 772 is operably coupled to body 524 and controllably repositions body 524 and port 750 relative to the outlets of sources 760, 762 and 764. In one implementation, actuator 770 and 772 may comprise a hydraulic or pneumatic cylinder-piston assembly, an electric solenoid, or other linear actuators. Such repositioning is under the control of controller 350 which outputs control signals to a properly position one of the sources in alignment with port 750 when the particular solution or fluid is to be deposited through port 750 into microfluidic passage 338. In some implementations, system 700 may omit one of actuators 770, 772.

In some implementations, each of the sources 760, 762 and 764 comprises a reservoir and a fluid ejector, such as a fluid ejector comprising a fluid actuator that ejects fluid through nozzle opening. In such implementations, micro volumes of fluid may be controllably deposited through port 750. In other implementations, each of sources 760, 762 and 764 may operate in different manners.

FIG. 14 is a schematic diagram illustrating portions of an example microfluidic magnetic microbead interaction device 820. FIG. 14 illustrates an example microfluidic magnetic microbead interaction device which is supplied with a sample solution through a first port and which is supplied with lyse fluid, wash fluid or elution fluid through a second port. Device 820 may be utilized for carrying out any of the above described methods and processes. Device 820 is similar to device 720 described above except that device 820 supplies the sample solution 327 through port 340 and selectively supplies lyse fluid, wash fluid or elution fluid through the port 750. As described above, in some implementations, the sample solution may contain the microbeads 26. In other implementations, the microbeads 26 may be pre-deposited within microfluidic passage 338 prior to the introduction sample 327.

Like device 720, device 820 comprises a part of a larger overall system 800 in which carriage 754 supports lyse fluid source 860, wash fluid source 862 and elution fluid source 864. Similar to system 700, system 800 comprises actuators 770 and 772 which move carriage 754 and device 820, respectively, to align an outlet of one of sources 860, 862, 864 with port 750. Those remaining components of system 800 and device 820 which correspond to components of system 700 and device 720 are numbered similarly.

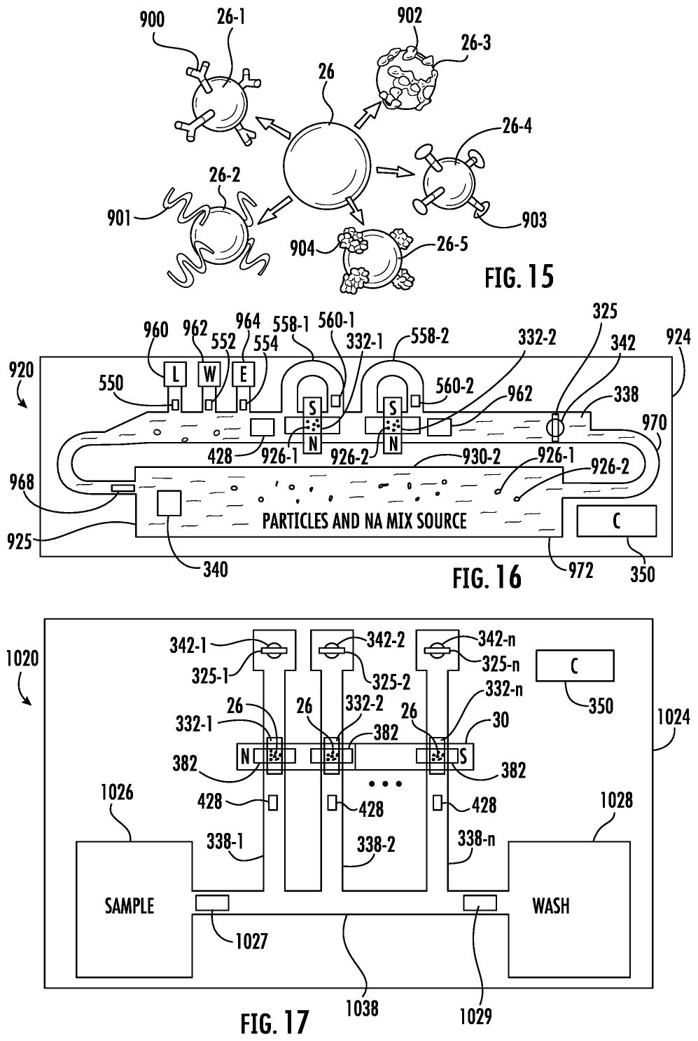

FIG. 15 is a diagram illustrating different coatings that may be applied to a microbead 26 to attract particular type of particle (bead attracted particles) within a sample solution. For example, ferromagnetic microbead 26-1 is illustrated as being coated with antibodies 900 for uses such as immunotherapy infectious disease tests. Ferromagnetic microbead 26-2 is illustrated as being coated with DNA probes 901 for uses such as SNPs analyses and gene diagnostic tests ???). Ferromagnetic microbead 26-3 is illustrated as being coated with adsorbent 902 for uses such as bacteria detection and cell trapping. Ferromagnetic microbead 26-4 is illustrated as being coated with fluorescent labels 903 for uses such as DNA analyses and fluorescent coding. Ferromagnetic microbead 26-5 illustrated as being coated with proteins 904 for uses such proteome analyses ???).

FIG. 16 illustrates an example microfluidic magnetic microbead interaction device 920. FIG. 16 illustrates an example of how multiple different targeted particles may be separated for collection and analyses from the same sample solution. Magnetic microbead interaction device 920 is similar to magnetic microbead interaction device 520 described above except that magnetic microbead interaction device 920 comprises body 924, lyse fluid source 960, wash fluid source 962, elution fluid source 964 and fluid pumps 550, 552 and 554. Body 924 is similar to body 524 and forms a large circulation loop 970 interconnecting a solution sample reservoir 972 and microfluidic passage 338. Solution sample reservoir 972 includes port 340 for the introduction of a solution sample which may include two different types of targeted particles and to types of microbeads 26 having different carry temperatures and different particle attracting coatings. In some implementations, the solution sample may additionally include other constituents such as cell growth media, primers, master mixes and the like.

Lyse fluid source 960, wash fluid source 962 and elution fluid source 964 comprise reservoirs formed on body 924 and connected to microfluidic passage 338. Pumps 550, 552 and 554, described above, selectively and controllably move fluid from source 960, 962 and 964, respectively, into microfluidic passage 338. As described above, in some implementations, pumps 550, 552 and 554 comprise inertial pumps. In some implementations, pump 550, 552 and 554 comprise thermal resistors that nucleate or vaporize adjacent fluid to form bubbles that displace fluid to inertially pump fluid from such sources into microfluidic passage 338.

As further shown by FIG. 16, device 920 comprises ferromagnetic microbeads 926-1, 926-2, magnets 30-1, 30-2, H/M 332-1, H/M 332-2, mixing loops 558-1, 558-2, fluid pumps 560-1, 560-2 and circulation pumps 960, 962. Those remaining components of magnetic microbead interaction device 920 which correspond to components of magnetic microbead interaction device 520 are numbered similarly and are shown in FIG. 11. Ferromagnetic microbeads 926-1, 926-2 are located within different heating zones of microfluidic passage 338 and have different cure temperatures and surface coatings for adhering to different types of particles/analytes in the same sample. Microbeads 926-1 have a first Curie temperature and are provided with a first coating, such as a first one of the coatings described above with respect to FIG. 15, whereas microbeads 926-2 have a second Curie temperature and are provided with a second different coating, such as a second one of coatings described above with respect to FIG. 15.

Magnets 30-1 and 30-2 are similar to magnet 30 described above. H/M 332-1 and H/M 332-2 are similar to H/M 332. Each of H/M 332-1 and H/M 332-2 are independently actuatable in response to control signals from controller 350. Mixing loops 558-1 and 558-2 as well as the associated fluid pumps 560-1 and 560-2 are similar to mixing loops 558 and 560 described above. Mixing loop 558-1 has an inlet and an outlet on opposite sides of magnet 30-1 and H/M 332-1. Similarly, mixing loop 558-2 has an inlet and outlet on opposite sides of magnet 30-2 and H/M 332-2. In the example illustrated, device 920 may additionally comprise lyser 428 described above. In some implementations, lyser 428 may be omitted given the provision of lyse fluid source 960 and pump 550.

Circulation pump 968 comprises a fluid pump to move fluid from reservoir 972 into microfluidic passage 338 on a first end of microfluidic passage 338. Circulation pump 962 comprise a fluid pump to move fluid from circulation passage 338 back into reservoir 972. In some implementations, pumps 968 and 962 each comprise inertial pumps. In some implementations, circulation pumps 969 62 each comprise thermal resistors that nucleate or vaporize adjacent fluid to create a bubble to displace fluid to inertially pump fluid.

In one example operation, controller 350 output control signals causing pump 968 to pump the sample solution and, potentially, microbeads 926-1 and 926-2 into microfluidic passage 338. At the same time or prior to such pumping, controller 350 outputs control signals causing H/M 332-2 to heat the adjacent region of fluid to a temperature above the Curie temperature of microbeads 926-1 and 560-2 while causing a H/M 332-1 to heat the adjacent region of fluid to a temperature above the Curie temperature of microbeads 926-2, but below the Curie temperature microbeads 926-1. As a result, microbeads 926-1 will maintain their ferromagnetism in the region of magnet 30-1 and aggregate at magnet 30-1. Thereafter, first target particles of the type that are to be attracted by microbeads 926-1 are separated out using microbeads 926-1, H/M 332-1 and recirculation loop 558-1 as described above with respect to FIG. 11. Such separation of the first target particles may involve the use of wash fluid and elution fluid as described above.

Upon separation and collection of the first target particles, such as the ejection of the collective target particles through ejection opening 342, the second target particles may be collected. For example, controller 350 may output control signals causing H/M 332-1 to heat adjacent regions of fluid to a temperature above the Curie temperature of both microbeads 926-1 and 926-2. At same time, controller 350 may output control signals to H/M 332-2 or discontinue the transmission of control signals to H/M 332-2 such that fluid adjacent magnet 30-2 is below the Curie temperature of microbeads 926-2 and such that microbeads 96-2 are ferromagnetic and magnetically aggregate at magnet 30-2. Thereafter, the second target particles of the second type that are to be attracted by microbeads 926-2 are separated out using microbeads 926-2, H/M 332-2 and recirculation loop 558-2 as described above with respect to FIG. 11. The collected second type of particles may then be ejected through nozzle opening 342 by fluid actuator 325 while attached to the microbeads or following elution. Such separation of the second target particles may involve the use of wash fluid and elution fluid as described above. In some implementation, such processes may be performed in parallel, wherein reservoir 925 is fluidically connected to multiple microfluidic passages 338 in parallel and wherein each individual passage 338 is fluidically connected to the fluid sources 960, 962, 964 and has an associated magnet, H/M, lyser, mixing loop and pump.

FIG. 17 is a schematic diagram illustrating portions of an example microfluidic magnetic microbead interaction device 1020. FIG. 17 provides an example of how such a device may provide multi-channel or multiplexed separation of different particles with a single magnet. Device 1020 may carry out any of the above described microfluidic magnetic microbead interaction methods. Device 1020 comprises body 1024, sample reservoir 1026, fluid pump 1027, wash reservoir 1028, fluid pump 1029, magnet 30, H/M 332-1, H/M 332-2 . . . H/M 332-n, nozzle openings 342-1, 342-2, . . . 342-n; fluid actuators 325-1, 325-2 . . . 325-n; and controller 350.

Body 1024 is similar to the above described bodies 524, 924 except the body 1024 forms supply passage 1038 and microfluidic passages 338-1, 338-2 . . . 338-n (collectively referred to as passages 338). Supply passage 1038 extends between and interconnects sample solution reservoir 1026 and wash fluid reservoir 1028. Supply passage 1038 is connected to each of microfluidic passages 338. Microfluidic passages 338 branch from supply passage 1038, in parallel and extend across magnet 30.

Sample solution reservoir 1026 comprises a reservoir to be filled or filled with a sample solution. In some implementations, sample solution reservoir 1026 contains microbeads 26. In some implementations, microbeads 26 are pre-provided within each of the microfluidic passages 338. For example, microbeads 26 may be in a lyophilized form proximate to H/Ms 332-1, 332-2 . . . 332-n. Fluid pump 1027 controllably draws sample solution from reservoir 1026 under the control of controller 350. In the example illustrated, pump 1027 comprises an inertial pump. In the example illustrated, pump 1027 comprises a thermal resistor which heats adjacent fluid to attempted to vaporize a fluid to create a bubble that displaces fluid for inertial pumping. In other implementations, pump 1027 may comprise other forms of fluidic pumps.

Wash fluid reservoir 1028 comprise a reservoir to be filled or filled with a wash fluid. Fluid pump 1029 controllably draws wash fluid from reservoir 1028 under the control of controller 350. In the example illustrated, pump 1029 comprises an inertial pump. In the example illustrated, pump 1029 comprises a thermal resistor which heats adjacent fluid to attempted to vaporize a fluid to create a bubble that displaces fluid for inertial pumping. In other implementations, pump 1029 may comprise other forms of fluidic pumps. In some implementations, body 10224 may additionally support an elution fluid reservoir 544 (shown in FIG. 11) connected to supply passage 1038 and associated with a pump 554 (shown in FIG. 11) for drawing elution fluid into supply passage 1038.

H/Ms 332 are each similar to H/M 332 described above. Nozzle openings 342 and fluid actuator 325 are each similar to nozzle opening 342 and fluid actuator 325, respectively, described above. During an example operation, controller 350 may control signals causing pump 10027 to supply sample solution (and potentially microbeads 26) to supply passage 1038. Controller 350 may further output control signals actuating selected or all of fluid actuators 325 to further draw the sample solution into the respective microfluidic passages 338. Thereafter, controller 350 may output control signals causing selected or all of H/Ms 332 to heat adjacent fluid and the nearby microbeads 26 to a temperature above the Curie tempter the microbeads 26, causing the microbeads to lose ferromagnetism and become suspended in the sample solution. Controller 350 may then output control signals causing H/M 332 to mix the suspended microbeads 26 to further promote adhesion of selected on the outer surfaces of the microbeads 26. Following such mixing, controller 350 may facilitate or allow the microbeads 26 to cool to a temperature below their Curie temperatures, causing the microbeads 26 to regain ferromagnetism and to be attracted towards magnet 30. As described above, this process of supplying a sample solution, followed by suspending, mixing, and aggregating the microbeads 26 may be carried out multiple times to concentrate selected particles from a larger sample.

Following such adsorption of the particles on the microbeads 26, controller 350 may output control signals causing pump 1029 to supply wash fluid to supply passage 1038. Controller 350 may then actuate selected or all of fluid actuators 325 to draw wash fluid into selected or all of microfluidic passages 338, washing the microbeads 26. Following such washing, the microbeads 26 with the attached particles may be ejected by fluid actuator 325. In some implementations where an elution source is provided, such particles may be separated from the microbeads 26, wherein the particles that were previously attached to the microbeads 26 may be discharged through nozzle openings 342 while the microbeads 26 remain within microfluidic passages 338.

As discussed above, in some implementations, each of microfluidic passages 338 may include a window to facilitate optical inspection or analyses. For example, in some implementations, each of microfluidic passages 338 may have a window 382 through which an optical sensor 384, such as microscope or camera (shown in FIG. 7C) may image the state of the particles within the respective microfluidic passages 338. As discussed above, in some implementations, the particles may be in the form of biological cells, wherein the parties may undergo lyses with lysers 428 in the respective microfluidic passages 338. In some implementations, an additional reservoir containing a master mix, primers, culture growth media and the like may be supplied to the megalithic passages 338, wherein biological cells may undergo thermal cycling and amplification such as with PCR (as described above with spec to FIGS. 7A-7C.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. A microfluidic magnetic microbead interaction device comprising:
a body having a microfluidic interior and a port connected to the microfluidic interior;
ferromagnetic microbeads within the microfluidic interior;
a magnet to exert a magnetic force on the ferromagnetic microbeads to attract the ferromagnetic microbeads to a region of the microfluidic interior;
a heater to heat fluid in the region to a temperature above a Curie temperature of the ferromagnetic microbeads; and
a mixer to mix fluid and the ferromagnetic microbeads while the fluid is at the temperature.

2. The device of claim 1 further comprising a controller to output control signals to the heater causing the heater to heat the fluid to the temperature above the Curie temperature of the ferromagnetic microbeads and to output control signals to the mixer to mix the fluid and ferromagnetic microbeads while the fluid is at the temperature above the Curie temperature of the ferromagnetic microbeads.

3. The device of claim 1, wherein the ferromagnetic microbeads are in a lyophilized form prior to introduction of fluid into the microfluidic interior.

4. The device of claim 1, wherein the mixer comprises a fluid actuator.

5. The device of claim 4, wherein the mixer comprises a thermal resistor.

6. The device of claim 4 comprising a thermal resistor, thermal resistor serving as the heater and the mixer.

7. The device of claim 1 further comprising:
an ejection orifice extending from the microfluidic interior; and
a fluid actuator to eject portions of the fluid within the microfluidic interior through the ejection orifice.

8. The device of claim 1, wherein the microfluidic interior comprises:
a microfluidic channel;
a mixing loop; and
a pump to move the fluid from the microfluidic channel into and through the mixing loop and back to the microfluidic channel.

9. The device of claim 1 further comprising:
second ferromagnetic microbeads within the microfluidic interior, the second ferromagnetic microbeads having a second Curie temperature different than the Curie temperature of the ferromagnetic microbeads, wherein the heater is to heat the fluid to a second temperature above the second Curie temperature; and
a recirculation loop in the body, the recirculation loop comprising the microfluidic interior.

10. The device of claim 1, wherein the body comprises:
a first microfluidic channel;
a second microfluidic channel extending from the microfluidic channel and forming the microfluidic interior;
a third microfluidic channel extending from the microfluidic channel;
second ferromagnetic microbeads within the third microfluidic channel, the second ferromagnetic microbeads having a second Curie temperature, wherein the magnet is to exert a magnetic force on the second ferromagnetic microbeads to attract the second ferromagnetic microbeads to a second region of the microfluidic interior;
a second heater to heat fluid in the second region to a second temperature above the second Curie temperature of the second ferromagnetic microbeads; and
a second mixer to mix the fluid within the third microfluidic channel while the fluid is at the second temperature.

11. A microfluidic magnetic microbead interaction method comprising:
mixing ferromagnetic microbeads in a fluid while the fluid is at a first temperature above a Curie temperature of the ferromagnetic microbeads;
applying a magnetic field to the ferromagnetic microbeads while the fluid is at a second temperature at or below the Curie temperature of the ferromagnetic microbeads; and
withdrawing remaining supernatant portions of the fluid while the magnetic field is applied to the ferromagnetic microbeads.

12. The method of claim 11, wherein the applying of the magnetic field to the ferromagnetic microbeads is in a microfluidic interior, the method further comprising introducing the fluid into the microfluidic interior, wherein the fluid being introduced contains while the ferromagnetic microbeads which are suspended in the fluid.

13. The method of claim 11, wherein the applying of the magnetic field to the ferromagnetic microbeads is in a microfluidic interior, the method further comprising introducing the fluid into the microfluidic interior, wherein the ferromagnetic microbeads are contained within the microfluidic interior prior to the introducing of the fluid into the microfluidic interior.

14. The method of claim 11 further comprising thermal cycling the fluid.

15. A microfluidic magnetic microbead interaction device comprising:
a body having a microfluidic interior and a port connected to the microfluidic interior, the microfluidic interior to receive ferromagnetic microbeads having a Curie temperature;
a magnet to exert a magnetic force to the microfluidic interior;
a heater to heat fluid introduced into the microfluidic interior;
a mixer to mix the fluid in the microfluidic interior; and
a controller to output control signals to the heater causing the heater to heat the fluid to the temperature above the Curie temperature of the ferromagnetic microbeads and to output control signals to the mixer to mix the fluid and the ferromagnetic microbeads while the fluid is at the temperature above the Curie temperature of the ferromagnetic microbeads.
